(19) United States
(12) Patent Application Publication
(10) Pub. No.: US 2007/0274794 A1
(43) Pub. Date: Nov. 29, 2007

(54) Oblique angle serration location and drive interface

(76) Inventor: Thomas J. Cirino, Kirtland, OH (US)

Correspondence Address: ROETZEL & ANDRESS, 1375 EAST 9TH STREET, CLEVELAND, OH, 44114, US

(21) Appl. No.: 11/717,322

(22) Filed: Mar. 13, 2007

Related U.S. Application Data
(63) Continuation-in-part of application No. 11/441,663, filed on May 26, 2006.

(51) Int. Cl. B23B 51/00

(52) U.S. Cl. 408/226

(57) ABSTRACT

A location and drive interface connection for machine tools and drive systems uses cooperating first and second sets of serrations at oblique angles on the mating surfaces of a drive component and a driven component for location and torque transfer. The oblique intersecting angles of the serrations provide for single precise location and alignment and high-efficiency torque transfer through the meshed serrations.

### RELATED APPLICATIONS

This application is a continuation-in-part of U.S. patent application Ser. No. 11/441,663, filed May 26, 2006.

### FIELD OF THE INVENTION

The present disclosure is in the general field of machinery, machine tools, mechanical coupling and drive systems, and metal cutting tools.

### BACKGROUND OF THE INVENTION

Replaceable cutting tools and inserts are used in connection with various cutting tool holders in metal working machinery for drilling, milling, boring, reaming and other cutting operations. Replaceable cutting tools eliminate the need to replace and exchange entire tools in continuous drilling and milling operations. For speed and efficiency, the manner of connection of replaceable cutting tools or tips with the holder or shank must be simple and fast, but with precise tolerance and adequate strength. The connection or interface of a cutting tool to its holder or mount must accomplish precise location and drive. For axial cutting operations such as drilling, milling, boring or reaming, the interface must locate and drive on-axis. The manner of engagement with a cutting or milling tip with the tool holder is somewhat dependent on the configuration of the cutting tip. In the case or replaceable drill tips, there is typically a generally cylindrical drill shank with a distal end to which a drill tip is attached, so there is abutment of two generally cylindrical forms of the tip and shank and very high torsional forces at the interface. Maintaining the drill tip on center is made difficult by the high torsional forces. Many different types of coupling systems which achieve initial centering eventually skew off-center as a result of faulty alignment and drive design, and material deformation at the drive interface, particularly in the case of a carbide cutting tip mounted to a steel shank or holder.

Some location and drive interface designs have used mating sets of parallel grooves, perpendicular grooves, perpendicular grooves which intersect, and radial arrays of grooves. A design disadvantage of parallel grooves is that, regardless of the fastening means used such as set screws, drift can occur along the direction of the grooves which carries the cutting tool off-axis. Perpendicular intersecting grooves at the interface can overcome this tendency, but can still allow some degree of slide or movement off center in one or the other directions of the grooves as wear of the drive contact surfaces of the grooves develops. Where different sets or directions of grooves have been made to partially intersect on the driving piece, the grooves in the mating cutting piece have been made to fully intersect in a waffle pattern to allow for indexing of the position of the cutting piece. Such indexing capability requires that there be only a single fastener or set screw axially located through both pieces.

### SUMMARY OF THE INVENTION

The following summary describes general attributes and features of the invention, and does not and is not intended to limit the scope of the invention in any manner, as defined by the claims and equivalents thereof.

The disclosure and invention is a location and drive interface between two components, including a driven component and a driving component, such as a cutting tool and a tool shank, drive shank or drill shank or drive shaft, or any other torque transfer mechanical coupling interface. First and second sets of serrations are formed at an oblique angle on an attachment end of the driven component, and matching first and second sets of serrations are formed at an oblique angle on an interface end of the driven component. The first and second sets of serrations on the drive component or shank are put into meshed engagement with the first and second sets of serrations on the interface end of the driven component for torque transfer to the driven component. With the first and second sets of serrations on each component formed at an oblique angle between 0 (zero) and 90 (ninety) degrees, the location and drive interface allows for only one precise on-axis positioning on the attachment end of the drive component, and highly efficient torque transfer through the meshed serrations. As used herein, the terms “interface” and “coupling interface” refers to the mechanical connection or coupling of one component, such as between a driven component such as a drill tip or cutting tool, and a drive component such as shaft or wheel.

In accordance with certain principles and concepts of the disclosure, there is provided location and drive interface for torque transfer connection of a driven component to a drive component, the location and drive interface having a driven component having an interface end with first and second sets of serrations formed at an oblique angle, the first set of serrations on the interface end formed at an oblique angle relative to the second set of serrations on the interface end, a drive component having an attachment end with first and second sets of serrations formed at an oblique angle, the first set of serrations on the attachment end formed at an oblique angle relative to the second set of serrations on the attachment end.

Also in accordance with certain principles and concepts of the invention, there is provided a locating and torque transfer coupling interface between a driven component and a drive component for single orientation of the driven component on an attachment end of the drive component and axial alignment of the driven component with the drive component, the coupling interface having first and second sets of serrations on an interface end of the driven component, the first set of serrations on the interface end of the driven component formed at an oblique angle relative to the second set of serrations on the interface end of the driven component, first and second sets of serrations on the attachment end of the drive component which mesh with the first and second sets of serrations on the interface end of the driven component in a single position which aligns a longitudinal axis of the driven component with a longitudinal axis of the drive component.

Also disclosed is a location and drive interface between a drill tip and an end of a drill shank, which includes obliquely angled sets of serrations formed on mating surfaces of the drill tip and drill shank. When assembled together, the obliquely angled sets of serrations on the drill tip and drill shank mesh to perfectly locate and align the drill tip with the drill shank, and provide driving contact for torque transfer rotation of the drill tip. The drill tip is secured to the mating surface of the drill shank by one or more set screws which extend axially through the drill tip and into the drill shank. The obliquely angled sets of serrations on the mating surfaces may intersect to form one or more islands with diamond-shaped perimeters which fit within mating serrations which intersect at an oblique angle.

In another aspect of the invention and disclosure, there is disclosed a location and drive interface for a torque transfer connection between a cutting tool and a shank, the shank having an attachment end for connection to an interface end of a cutting tool, the attachment end of the shank having first an second sets of parallel serrations, the first set of serrations on the attachment end at an oblique angle relative to the second set of serrations on the attachment end, the interface end of the cutting tool having first and second sets of parallel serrations which mesh with the first and second sets of serrations on the attachment end of the shank.

These and other aspects and principles and concepts of the disclosure are described as representative examples of the design concepts and principles in the following detailed description.

### DESCRIPTION OF THE DRAWINGS

FIG. 1A is an end view of a drill tip end with obliquely angled serrations;

FIG. 1B is a profile view of the drill tip of FIG. 1;

FIG. 2A is an end view of a drill shank end with obliquely angled serrations;

FIG. 2B is a profile view of and end segment of the drill shank of FIG. 3;

FIG. 3A is a profile view of a drill tip of the invention;

FIG. 3B is an alternate profile view of the drill tip of FIG. 3A;

FIG. 3C is an end view of the drill tip of FIG. 3A;

FIG. 3D is a perspective view of the drill tip of FIG. 3A;

FIG. 3E is an end view of a carbide blank of the present invention;

FIG. 3F is a profile view of the carbide blank of FIG. 3E;

FIG. 3G is an enlarged profile view of serrations in the carbide blank of FIG. 3E and 3F;

FIG. 3H is an end view of a steel shank of the present invention;

FIG. 3I is a profile view of the steel shank of FIG. 3H;

FIG. 3J is an enlarged profile view of serrations in the steel shank of FIGS. 3H and 3I;

FIG. 4A is a profile view of a drill tip of the invention;

FIG. 4B is an alternate profile view of the drill tip of FIG. 4A;

FIG. 4C is an end view of the drill tip of FIG. 4A;

FIG. 4D is a perspective view of the drill tip of FIG. 4A;

FIG. 4E is an end view of a carbide blank of the present invention;

FIG. 4F is a profile view of the carbide blank of FIG. 4E;

FIG. 4G is an enlarged profile view of serrations in the carbide blank of FIG. 4E and 4F;

FIG. 4H is an end view of a steel shank of the present invention;

FIG. 4I is a profile view of the steel shank of FIG. 4H;

FIG. 4J is an enlarged profile view of serrations in the steel shank of FIGS. 4H and 4I;

FIG. 5A is a profile view of a drill tip of the invention;

FIG. 5B is an alternate profile view of the drill tip of FIG. 5A;

FIG. 5C is an end view of the drill tip of FIG. 5A;

FIG. 5D is a perspective view of the drill tip of FIG. 5A;

FIG. 5E is an end view of a carbide blank of the present invention;

FIG. 5F is a profile view of the carbide blank of FIG. 5E;

FIG. 5G is an enlarged profile view of serrations in the carbide blank of FIG. 5E and 5F;

FIG. 5H is an end view of a steel shank of the present invention;

FIG. 5I is a profile view of the steel shank of FIG. 5H;

FIG. 5J is an enlarged profile view of serrations in the steel shank of FIGS. 5H and 5I;

FIG. 6A is an end view of an oblique angle serration interface of the invention;

FIG. 6B is a profile view of an oblique angle serration interface of the invention;

FIG. 6C is an enlarged profile view of serrations of the oblique angle serration interface of the invention;

FIG. 7A is an end view of an oblique angle serration interface of the invention;

FIG. 7B is a profile view of an oblique angle serration interface of the invention;

FIG. 7C is an enlarged profile view of serrations of the oblique angle serration interface of the invention;

FIG. 8 is a plan view of an oblique angle serration interface of the invention showing projections of the intersecting oblique angles of the serrations;

FIGS. 9A-9I are representative profiles of serrations of the oblique angle serration interface of the invention;

FIG. 10A is a perspective view of a drilling tool with an oblique angle serration interface between a drill tip and a drill shank;

FIG. 10B is a perspective view of an interface end of the drill tip of FIG. 10A;

FIG. 10C is a profile view of the drill tip of FIG. 10A;

FIG. 10D is an end view of an interface end of the drill tip of FIG. 10C;

FIG. 10E is a profile view of the drill shank of FIG. 10A;

FIG. 10F is an end view of the drill shank of FIG. 10E;

FIG. 10G is an end view of an interface end of a drill tip with oblique angle serrations at a 5 degree angle of convergence;

FIG. 10H is an end view of an interface end of a drill tip with oblique angle serrations at a 30 degree angle of convergence;

FIG. 10I is an end view of an interface end of a drill tip with oblique angle serrations at a 45 degree angle of convergence;

FIG. 11A is a perspective view of a boring tool with an oblique angle serration interface of the invention;

FIG. 11B is an end view of the boring mill head of FIG. 11A;

FIG. 11C is a profile view of the boring mill tool of FIG. 11A;

FIG. 11D is a profile view of the boring mill head of FIG. 11C;

FIG. 11E is an end view of the interface end of the boring mill head of FIG. 11D;

FIG. 11F is an end view of the interface end of the boring mill adapter shown in FIGS. 11A and 11B;

FIG. 11G is a profile view of the boring mill adaptor shown in FIGS. 11A and 11B;

FIG. 12A is a perspective view of a endmill tool with an oblique angle serration interface of the invention;

FIG. 12B is an end view of the endmill head of FIG. 12A;

FIG. 12C is a profile view of the endmill tool of FIG. 12A;

FIG. 12D is a profile view of the endmill head of FIG. 12C;

FIG. 12E is an end view of the interface end of the endmill head of FIG. 12D;

FIG. 12F is an end view of the interface end of the endmill adapter shown in FIGS. 12A and 12B;

FIG. 12G is a profile view of the endmill adaptor shown in FIGS. 12A and 12B;

FIG. 13A is a perspective view of a reamer tool with an oblique angle serration interface of the invention;

FIG. 13B is an end view of the reamer head of FIG. 13A;

FIG. 13C is a profile view of the reamer tool of FIG. 13A;

FIG. 13D is a profile view of the reamer head of FIG. 13C;

FIG. 13E is an end view of the interface end of the reamer head of FIG. 13D;

FIG. 13F is an end view of the interface end of the reamer adapter shown in FIGS. 13A and 13B, and

FIG. 13G is a profile view of the endmill adaptor shown in FIGS. 13A and 13B;

### DETAILED DESCRIPTION OF PREFERRED AND ALTERNATE EMBODIMENTS

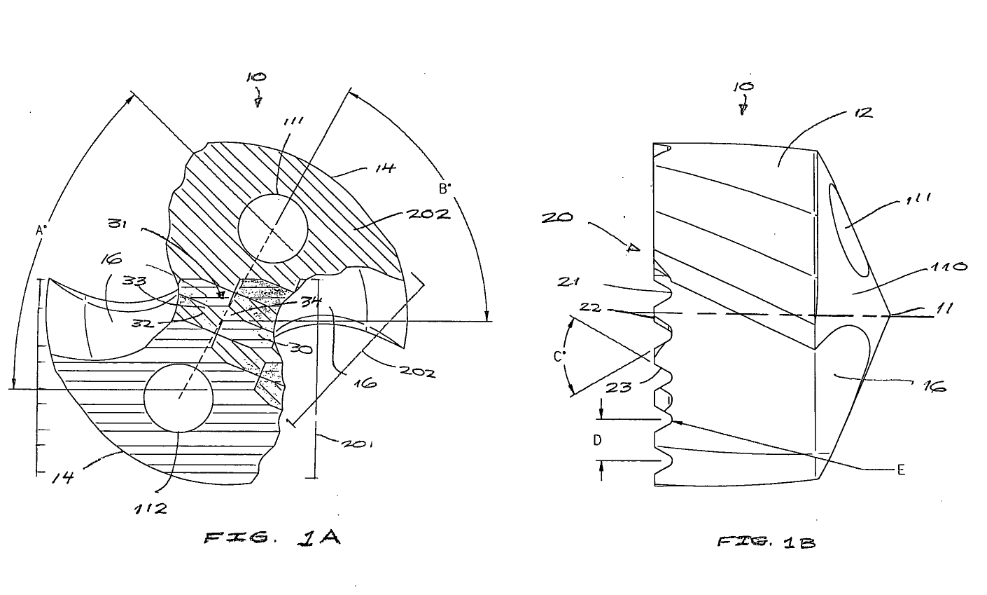

As shown in FIGS. 1A-1B, a drill tip 10 has a body 12 which in this particular form has a generally cylindrical configuration with generally opposed arcuate or chamfered sides 14 and generally helical chip flutes (“flutes”) 16 disposed radially and helically between the sides 14. The drill tip has at one end of the body 12 an axial point 11 at the apex of tapered drill head 110. An interface end 20, shown in its entirety in FIG. 1A, is formed at an opposite end of the body 12. The interface end 20 has formed in it first and second sets of obliquely angled serrations 201 and 202. The first set of serrations 201 is oriented with respect to the second set of serrations 202 at an oblique angle, i.e., neither perpendicular nor parallel to each other. The designations “first” and “second” with respect to the sets of serrations 201 and 202 are fungible and for reference only. The oblique angle of orientation of the first and second sets of serrations 201 and 202 can be any angle between 0 (zero) degrees and 90 (ninety) degrees. In other words, the indicated angle A may be any angle between 0 (zero) degrees and 90 (ninety) degrees. The serrations of the first and second sets of serrations 201, 202, are formed by generally linear grooves 21 and ridges 22 of any suitable profile, as further described. As used herein, the terms “serration” and “serrations” refer generally to the undulating surface formed by at least one groove and a corresponding parallel ridge or any portions thereof, and the phrase “sets of serrations” refers to two or more parallel grooves or ridges. One serrations may be considered or measured as from one groove to an immediately adjacent parallel groove with a single ridge therebetween, or from one ridge to an immediately adjacent parallel ridge with a single groove therebetween. Because the first and second sets of serrations 201 and 202 are oriented at an oblique angle, i.e., any angle between 0 (zero) degrees and 90 (ninety) degrees, there may be formed an area of intersection 30 of the serrations on the interface end 20, indicated as the shaded area 30. Within area 30 there may be formed one or more islands 31 or portion thereof, and each island 30 has a generally diamond-shaped perimeter 32 or portion thereof, and contoured or shaped flanks 33 which extend from lateral grooves 21 to a top 34 of the island 31. The flanks 33 of the island(s) 31 have the same profiles of the serrations 201, 202, as further described, as they are formed along with the grooves 21. A longitudinal axis of the drill tip 10, i.e., the “driven component”, shown in FIG. 1B, is located within the area of intersection 30 of the first and second sets of serrations 201, 202.

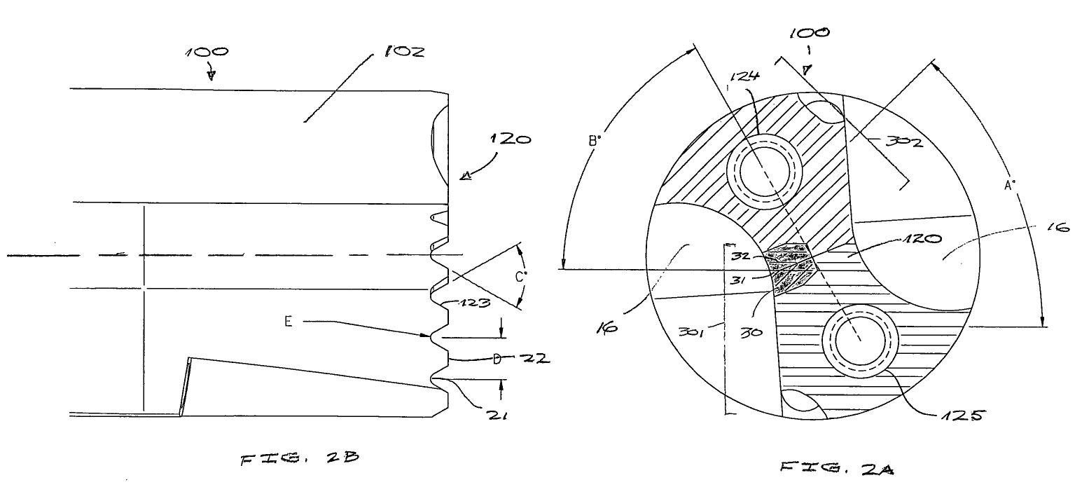

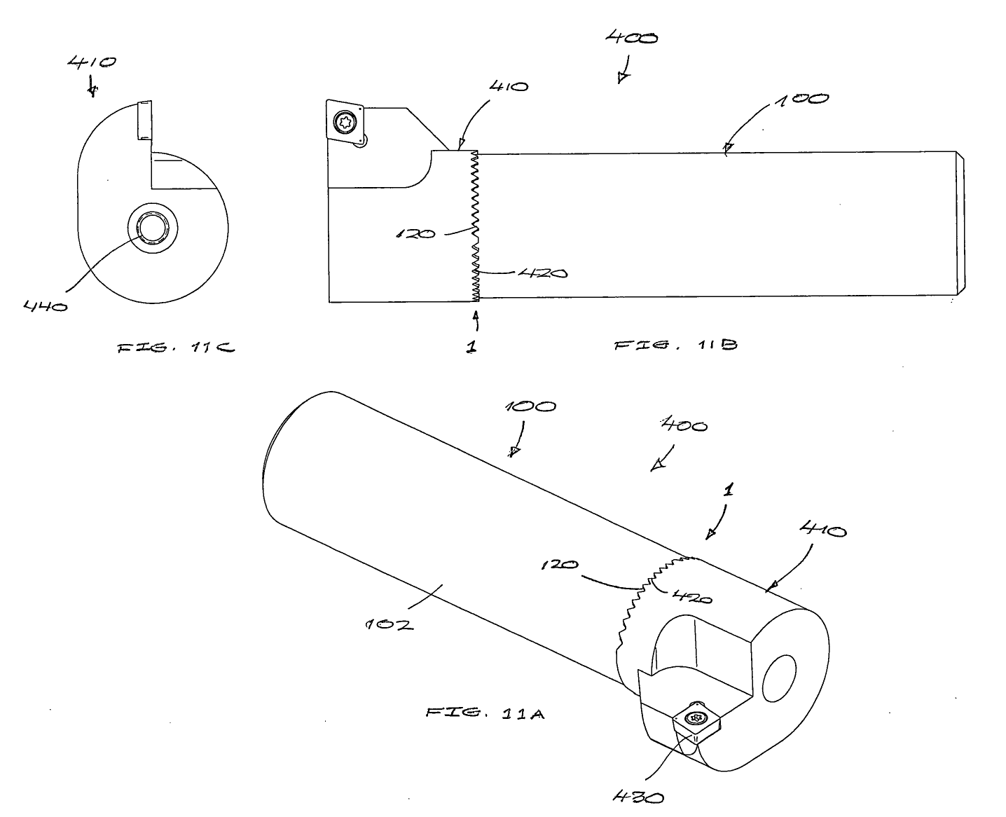

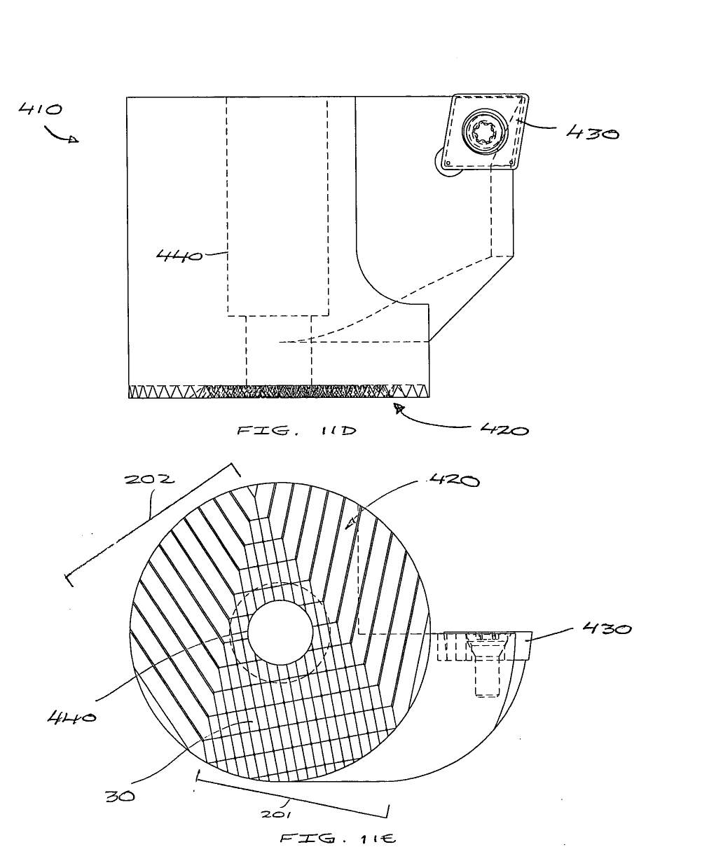

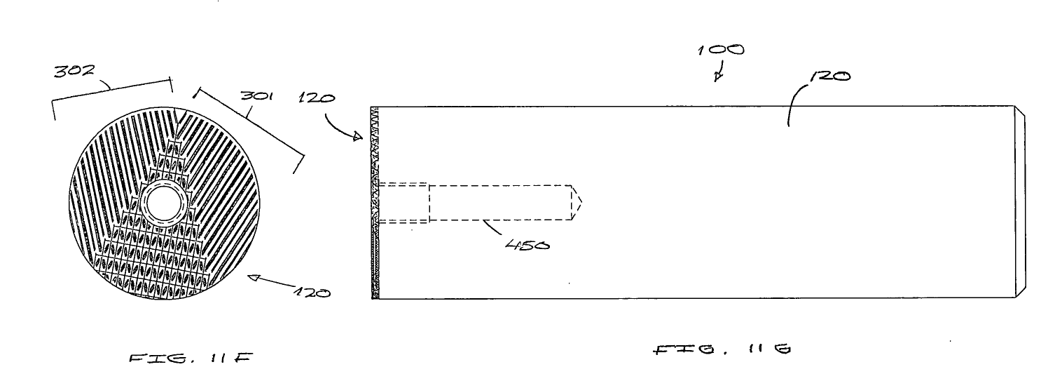

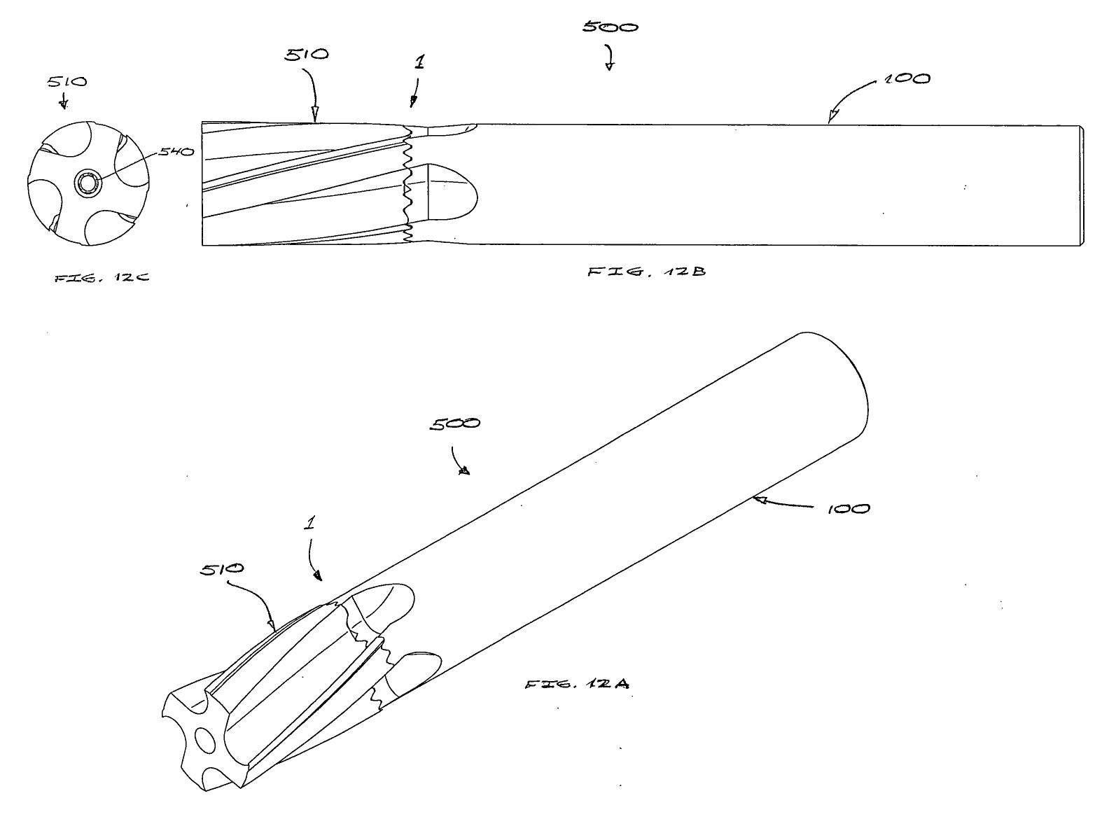

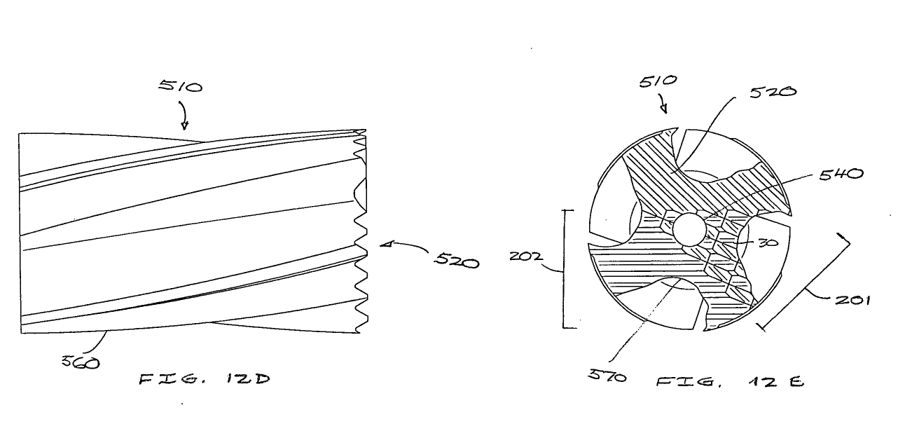

Referring to FIGS. 2A and 2B, there is shown a drill shank 100 having a generally cylindrical body 102 and an attachment end 120 which is typically a distal end from a butt end (not shown) which is held within a chuck or other fitting for machining or drilling operations. Corresponding flutes 16 are formed in the drill shank body 102 to match the flutes of the drill tip 10 as further described. On the attachment end 120 are formed first and second sets of serrations 301 and 302 which are oriented at an oblique angle A, which corresponds to the oblique angle of the first and second sets of serrations 201, 202 on the drill tip 10. The first set of serrations 301 of the drill shank 100 are offset or out of phase with the first set of serrations 201 of the drill tip 10. The second set of serrations 302 of the drill shank 100 are offset or out of phase with the second set of serrations 202 of the drill tip 10. Therefore, when the drill tip 10 is positioned with the interface end 20 against the attachment end 120 of the drill shank 100, the respective first and second sets of serrations 201, 301 and 202, 302 mesh together in the only manner or orientation possible, with the drill tip and drill shank axially aligned, i.e., with the longitudinal axis of the drill tip 10 aligned with the longitudinal axis of the drill shank 102. The drill tip 10 is axially secured to the drill shank 100 by set screws of other fasteners (not shown) which fit in through-bores 111 and 112 which are aligned with corresponding taps 124 and 125 in the drill shank end 120. The drill tip 10 is one example of what is alternatively referred to herein as a “driven component”, and the shank 100 one example of what is alternatively referred to herein as a “drive component”. The meshed engagement of the first and second sets of serrations 201, 202 and 301, 302 constitute a location and drive interface 1, shown in the engaged condition in FIGS. 11A-11B, 12A-12B and 13A-13B as further described. The first and second sets of serrations 301, 302 on the attachment end 120 of the drill shank 100 may intersect on the attachment end 120 to form an area of intersection 30, which may include one or more, or a portion of an island 31 and a diamond-shaped perimeter 32 or portion thereof. The area of intersection 30 on the attachment end 120 of the drill shank is in facing engagement with or overlapped by the area of intersection 30 on the interface end 20 of the drill tip 10 in the location and drive interface. In many applications, the total number of serrations which make up the first and second sets of serrations 201, 202 on the interface end 20 of the drill tip 10 or other driven component will be equal to or approximately equal to the total number of serrations which make up the first and second sets of serrations 301, 302 on the attachment end 120 of the drill shank 100 or driven component. In some embodiments, the areas of intersection 30 on the interface end 20 of the drill tip 10 and on the attachment end 120 of the shank 100 are less than an area covered by the respective first and second sets of serrations.

The following described embodiments are in the context of drilling tools, but as will be further explained the oblique angle serration location and drive interface is applicable to any types of tools or drive systems which require precise coupling and high-strength, high-efficiency torque-transfer, and particularly for rotational couplings which require only a single precise on-axis meshed engagement. Although the following examples are with reference to rotary driven machine tools, the location and drive interface is applicable to any rotary mechanical coupling regardless of the form or function of the driven component such as a drill tip or gear or wheel, and regardless of the form of the drive component such as a shaft or wheel.

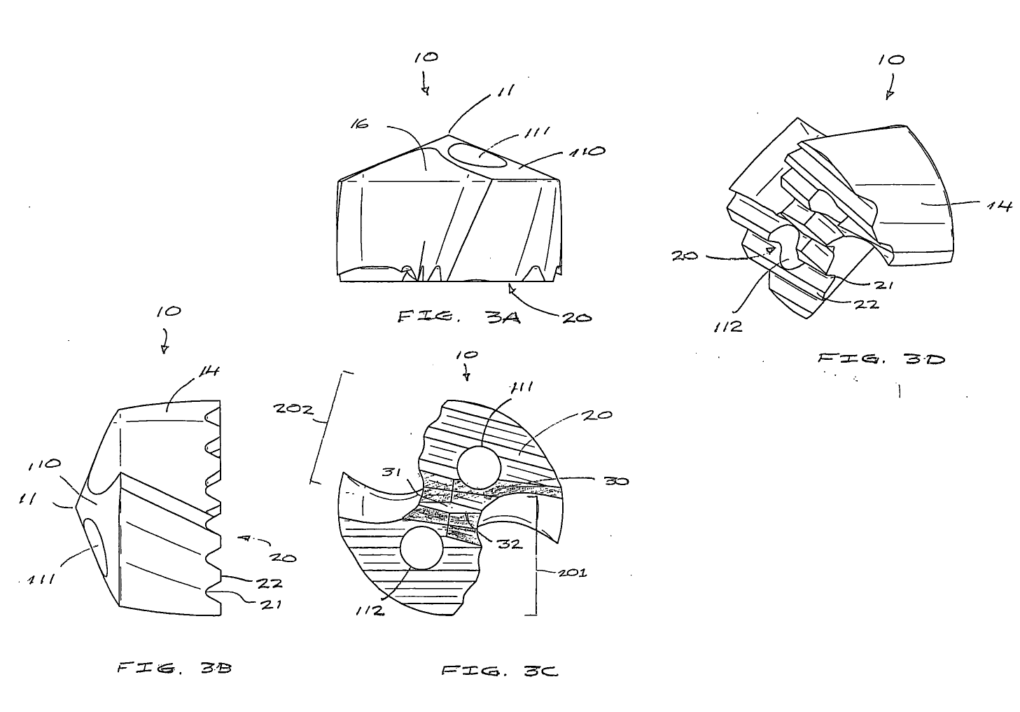

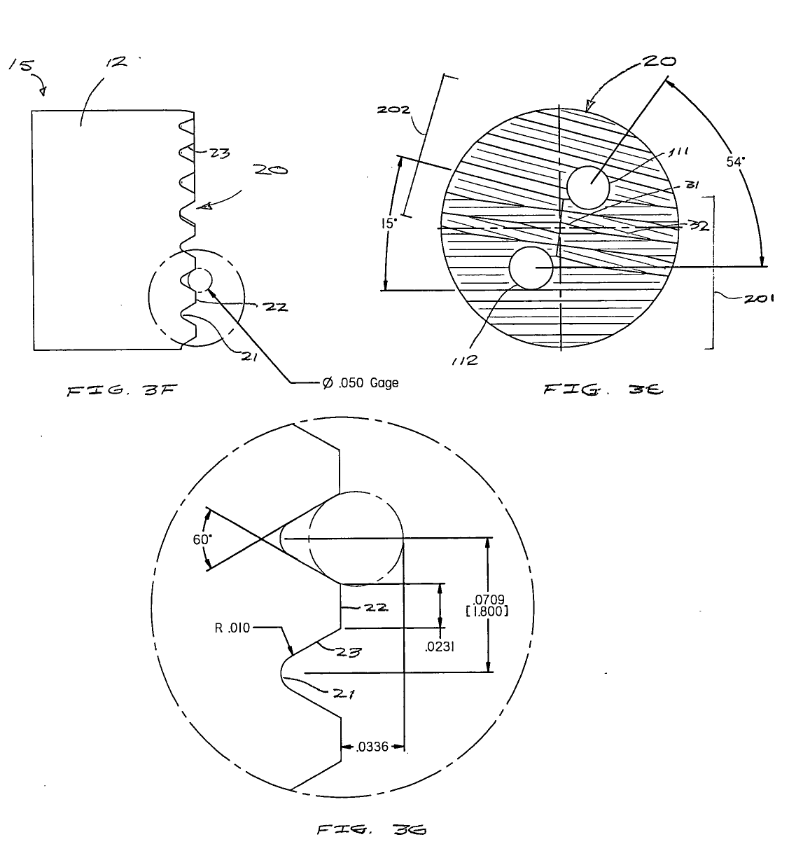

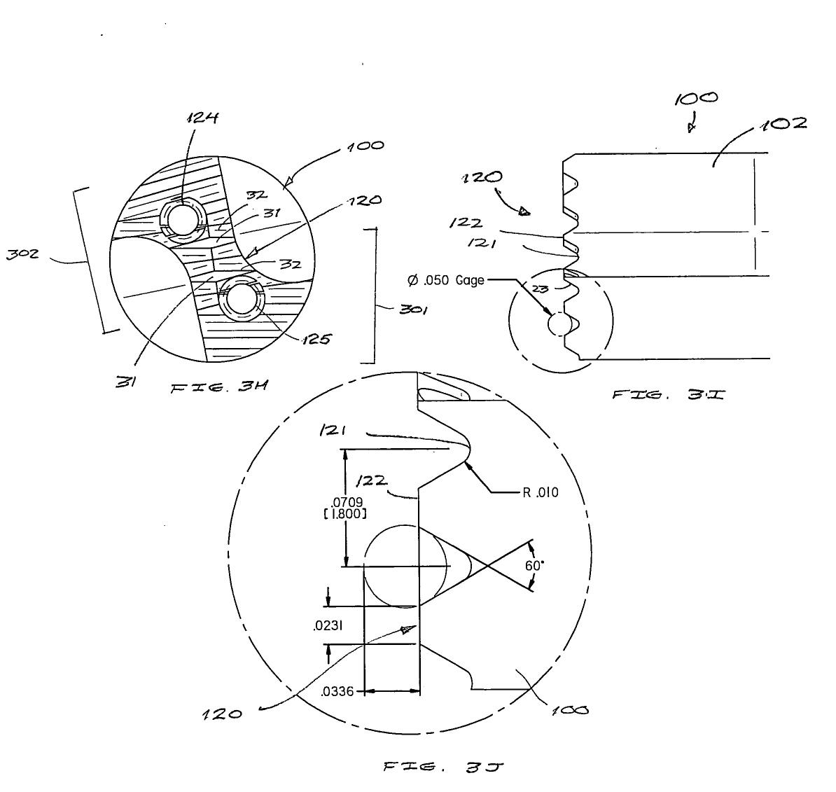

FIGS. 3A-3J illustrate an alternate embodiment of a drill tip and drill shank with a location and drive interface of oblique angle serrations in accordance with the principles of the invention, wherein the respective first and second sets of serrations 201, 202, 301, 302 are formed at an oblique angle of 15 (fifteen) degrees (as indicated on FIG. 3E). An area of intersection 30 is formed by the oblique angle convergence of the first and second sets of serrations 201, 202 on the interface end 20 of the drill tip 10. The area 30 of intersection may include one or more islands 31 with a diamond-shaped perimeter 32. The aspect ratio of the diamond-shaped perimeter 32 is determined by the oblique angle of intersection of the first and second sets of serrations 201, 202. The diamond-shaped perimeter 32 may be considered to be at the top surface 34 of the island 31, or at the bottom of the serration grooves surrounding the island 31. The area of intersection 30, as may be formed on the attachment end 120 of the shank or on the interface end 20 of the drill tip 10 or other driven component, is preferably less than an area of the respective first and second sets of serrations 201, 202, or 301, 302.

As shown in FIGS. 3E-3G, a blank 15, from which a drill tip or other tool may be formed, has a cylindrical body 12, and an interface end 20 in which the first and second sets of serrations 201, 202 are formed. In this particular example, the first and second sets of serrations 201, 202 are formed at an oblique angle of 15 (fifteen) degrees, as indicated on FIG. 3E. In one form, the profiles of the serrations 201, 202 may be formed at a specified radial gauge as indicated, with radiused grooves 21 and truncated ridges 22, with generally linear flanks 23 at a specified angle tangent to the radial gauge. The blank 15 may be any component or part which is to be located relative to a drive or shank and rotationally driven, including without limitation a drill tip, a blank, an intermediate coupling, a clutch component, a cutting tool, a reaming tool, a boring tool, an endmill, a tool holder or a gear or other rotary component.

As shown in FIGS. 3H-3J, a drill shank 100, for engaging with and driving the drill tip 10, has a generally cylindrical body 102 with an attachment end 120, on which first and second sets of serrations 301, 302 are formed, at the same oblique angle, e.g. 15 (fifteen) degrees as that on the interface end 20 of the blank 15, and offset or out of phase by the width of one serration for meshed engagement with interface end 20 of blank 15 and axial alignment of blank 15 with shank 100. As with the blank 15, the profiles of the serrations 301, 302 may be formed at a specified radial gauge as indicated, with radiused grooves 21 and truncated ridges 22, and generally linear flanks 23 at a specified angle tangent to the radial gauge for meshing with the serrations 201, 202 of the blank 15.

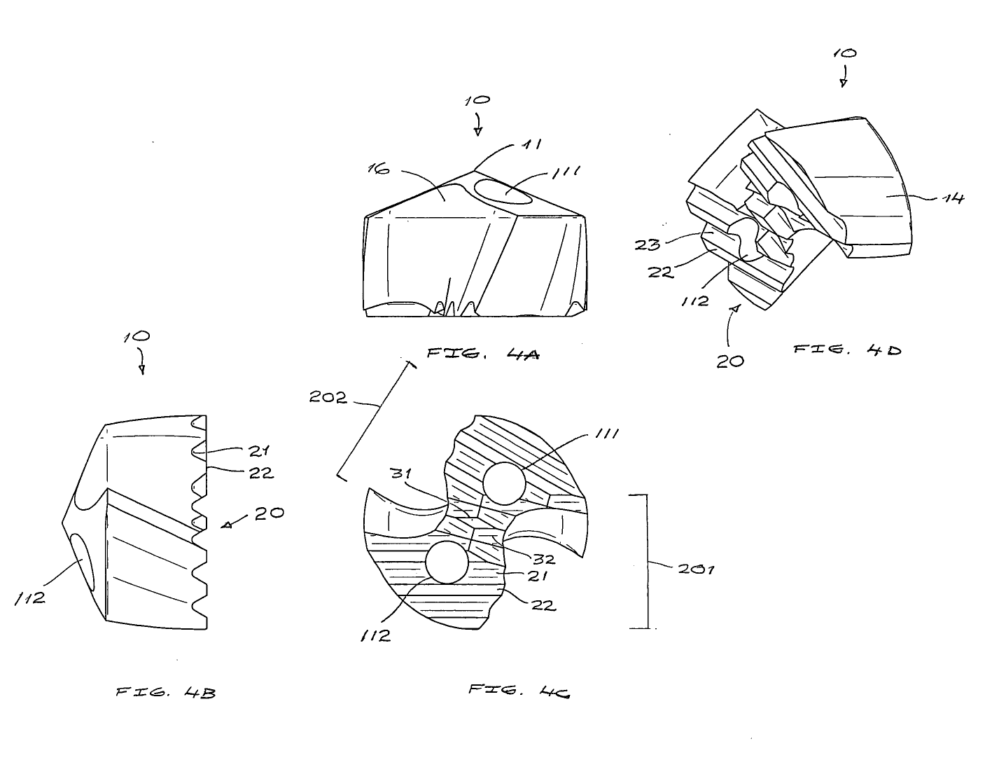

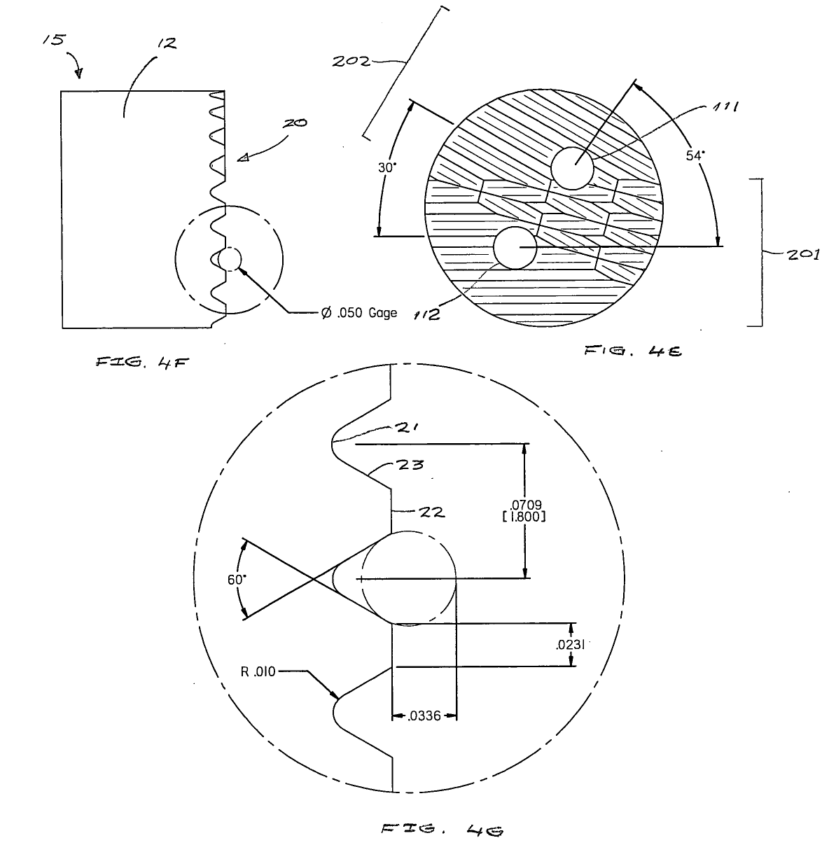

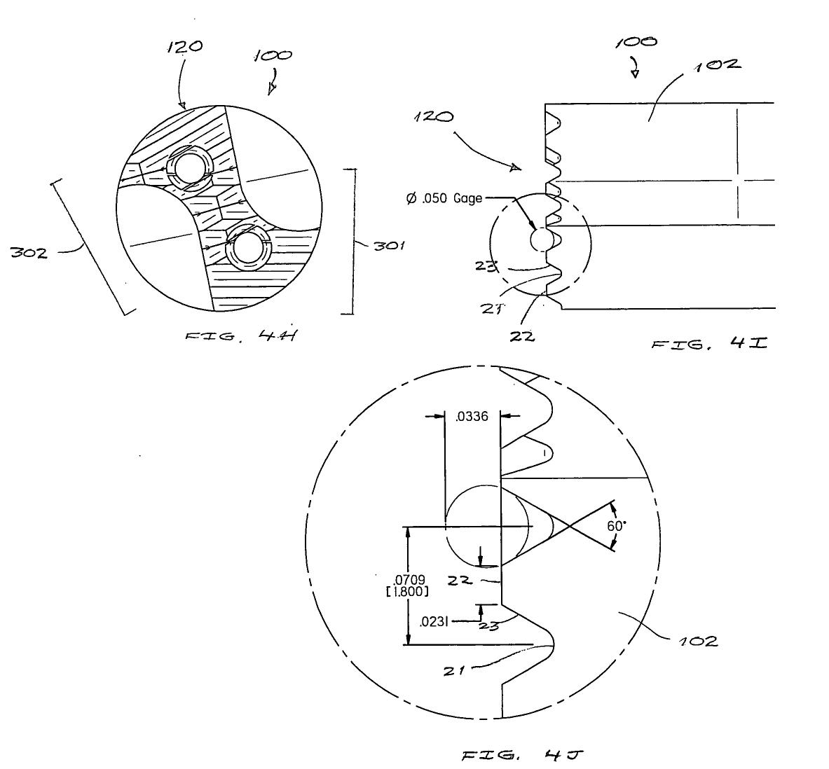

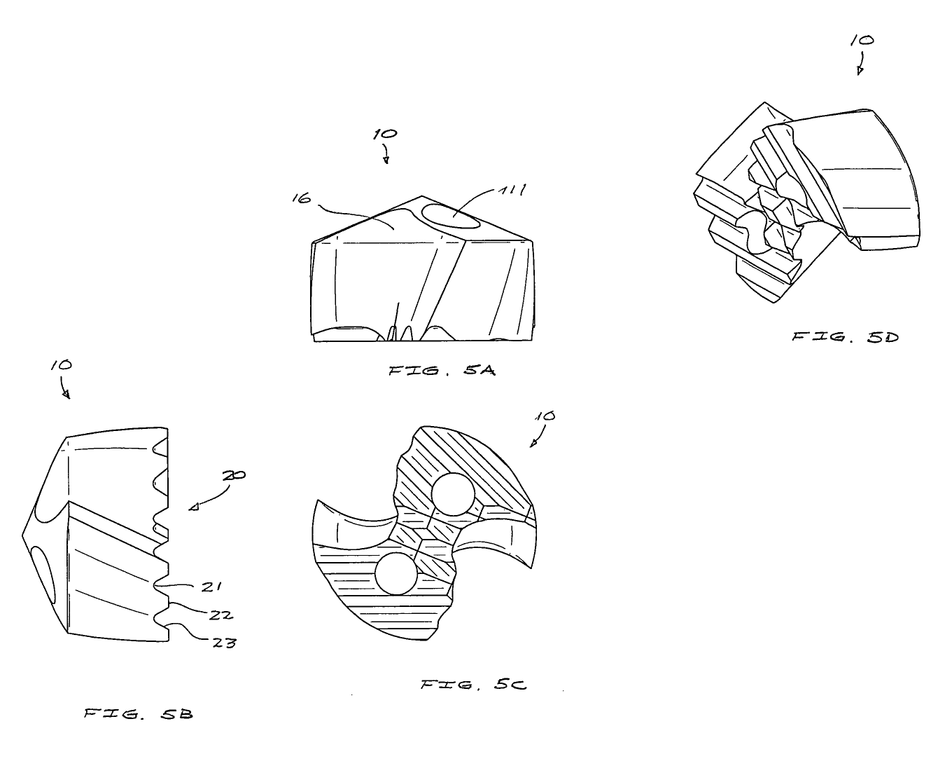

FIGS. 4A-4J illustrate an alternate embodiment of a drill tip and drill shank with an oblique angle serration location and drive interface, wherein the sets of serrations 201, 202 on the drill tip 10 (FIGS. 4A-4D) or blank 15 (FIGS. 4E-4G), and serrations 301, 302 on shank 100 (FIGS. 4H-4J) are formed at an oblique angle of 30 (thirty) degrees, as indicated. An area of intersection, generally shaded as 30, is formed on the interface end 20 by the oblique angle of convergence of the first and second sets of serrations 201, 202. Within the area 30 of intersection one or more islands 31 are formed with a diamond-shaped perimeter 32. The aspect ratio of the diamond-shaped perimeter 32 is determined by the oblique angle of intersection of the first and second sets of serrations 201, 202. The diamond-shaped perimeter 32 may be considered to be at the top surface 34 of the island 31, or at the bottom of the serration grooves surrounding the island 31. As shown by comparison of FIGS. 4C and 3C, the number of islands 31 and the aspect ratio of the diamond-shaped perimeter 32 changes with the oblique and of the first and second sets of serrations.

As shown in FIGS. 4E-4G, a blank 15, from which a drill tip or other tool may be formed, has a cylindrical body 12, and an interface end 20 in which the first and second sets of serrations 201, 202 are formed. In this particular example, the first and second sets of serrations 201, 202 are formed at the oblique angle of 30 (thirty) degrees, as indicated on FIG. 4E. Although the profiles of the serrations 201, 202 are illustrated as formed at a specified radial gauge, with radiused grooves 21 and truncated ridges 22, with generally linear flanks 23 at a specified angle tangent to the radial gauge, it is understood that other serration profiles and configurations may be employed and selected for or designed with the corresponding oblique angle of the serration sets.

As shown in FIGS. 4H-4J, a shank 100, such as a drill or tool shank, for engaging with and driving the blank 15 or drill tip 10, has a generally cylindrical body 102 with an attachment end 120, on which first and second sets of serrations 301, 302 are formed, at the same oblique angle, e.g. 30 (thirty) degrees as that on the interface end 20 of the blank 15, and offset or out of phase by the width of one serration for meshed engagement with interface end 20 of blank 15 and axial alignment of blank 15 with shank 100. As with the blank 15, the profiles of the serrations 301, 302 may be formed at a specified radial gauge as indicated, with radiused grooves 21 and truncated ridges 22, and generally linear flanks 23 at a specified angle tangent to the radial gauge for meshing with the serrations 201, 202 of the blank 15.

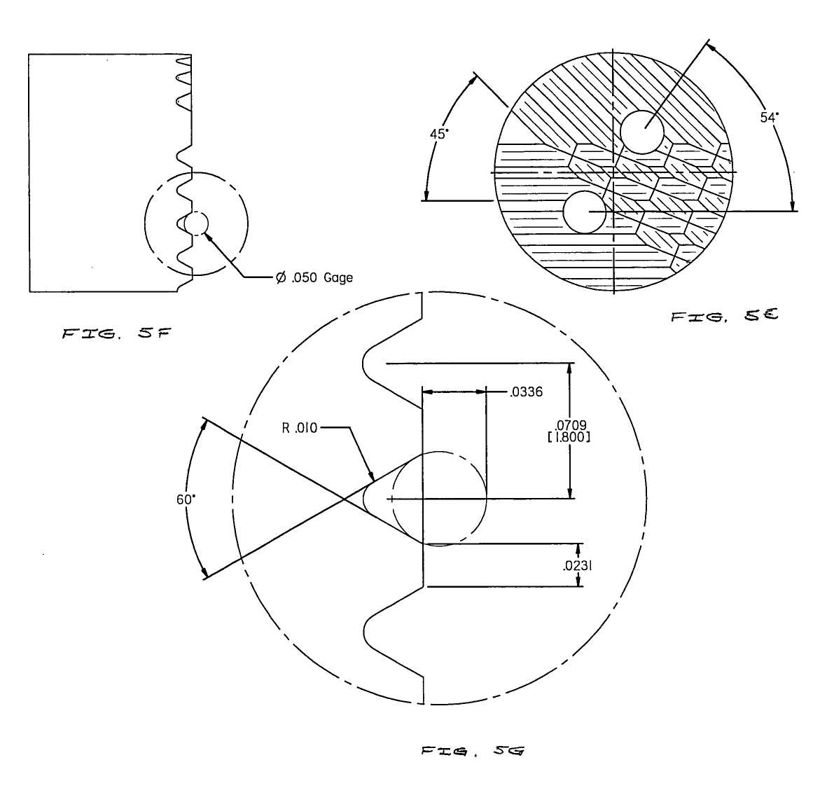

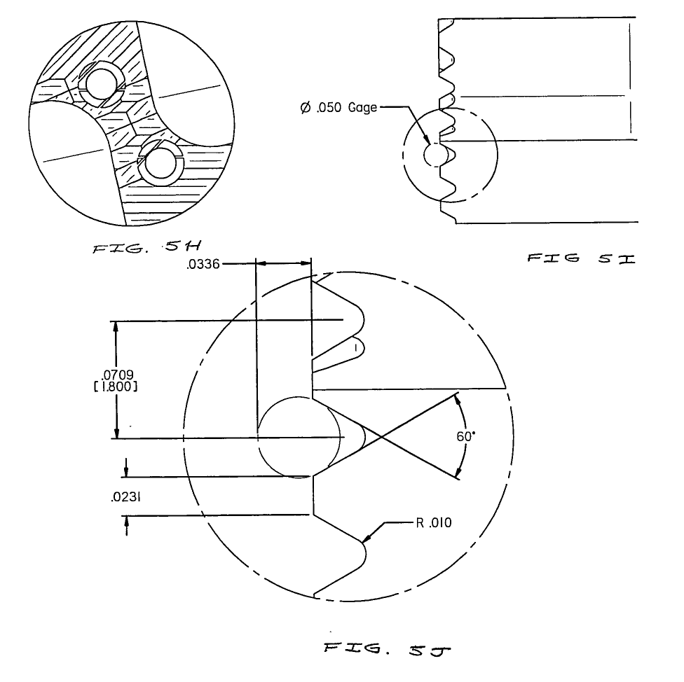

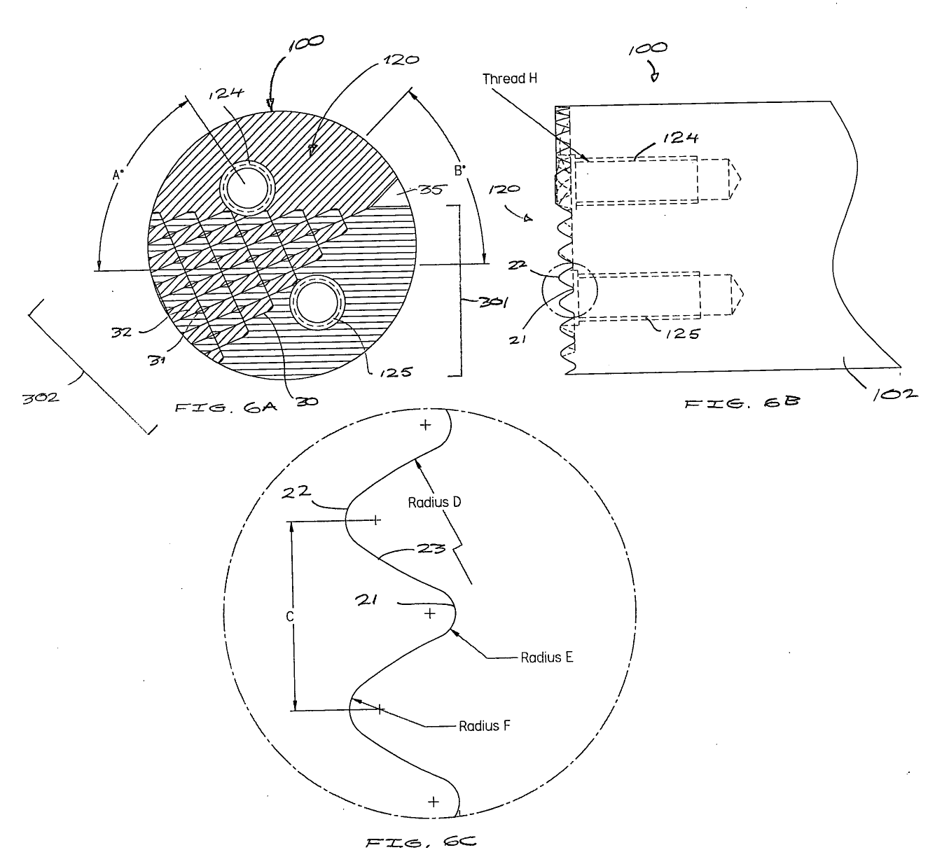

FIGS. 5A-5J illustrate an alternate embodiment of a working or cutting piece, such as a drill tip, and a driving piece such as a shank or tool holder or drill shank with an oblique angle serration location and drive interface for torque transfer from the driving piece to the cutting piece. As shown in FIGS. 5A-5D, the first and second sets of serrations 201, 202 on the drill tip 10 or blank 15 (FIGS. 5E-5G), and first and second sets of serrations 301, 302 on shank 100 (FIGS. 5H-5J) are formed at an oblique angle of 45 (forty-five) degrees, as indicated. An area of intersection, generally shaded as 30, is formed on the interface end 20 by the oblique angle of convergence of the first and second sets of serrations 201, 202. Within the area 30 of intersection one or more islands 31 are formed with a diamond-shaped perimeter 32. The aspect ratio of the diamond-shaped perimeter 32 is determined by the oblique angle of intersection of the first and second sets of serrations 201, 202. The diamond-shaped perimeter 32 may be considered to be at the top surface 34 of the island 31, or at the bottom of the serration grooves surrounding the island 31. As shown by comparison of FIGS. 3C, 4C and 5C, the number of islands 31 and the aspect ratio of the diamond-shaped perimeter 32 changes with the oblique and of the first and second sets of serrations.

As shown in FIGS. 5E-5G, a blank 15, from which a drill tip or other tool may be formed, has a cylindrical body 12, and an interface end 20 in which the first and second sets of serrations 201, 202 are formed. In this particular example, the first and second sets of serrations 201, 202 are formed at the oblique angle of 45 (forty-five) degrees, as indicated on FIG. 5E. Although the profiles of the serrations 201, 202 are illustrated as formed at a specified radial gauge, with radiused grooves 21 and truncated ridges 22, with generally linear flanks 23 at a specified angle tangent to the radial gauge, it is understood that other serration profiles and configurations may be employed and selected for or designed with the corresponding oblique angle of the serration sets.

As shown in FIGS. 5H-5J, a shank 100, such as a drill or tool shank, for engaging with and driving the blank 15 or drill tip 10, has a generally cylindrical body 102 with an attachment end 120, on which first and second sets of serrations 301, 302 are formed, at the same oblique angle, e.g. 45 (forty-five) degrees as that on the interface end 20 of the blank 15, and offset or out of phase by the width of one serration for meshed engagement with interface end 20 of blank 15 and axial alignment of blank 15 with shank 100. As with the blank 15, the profiles of the serrations 301, 302 may be formed at a specified radial gauge as indicated, with radiused grooves 21 and truncated ridges 22, and generally linear flanks 23 at a specified angle tangent to the radial gauge for meshing with the serrations 201, 202 of the blank 15.

In each of the location and drive interfaces described, torque transfer (“drive”) from the drive piece, e.g., shank 100, to the driven piece, e.g. drill tip 10 or blank 15, occurs through the meshed engagement of the respective serrations, 201 with 301, and 202 with 302. Although as described there is some intersection of the first and second sets of serrations 201, 202 and 301, 302, the intersection occurs only as a result of forming a substantial linear portion of the serrations on drive interface of each component, and for achieving co-axial location.

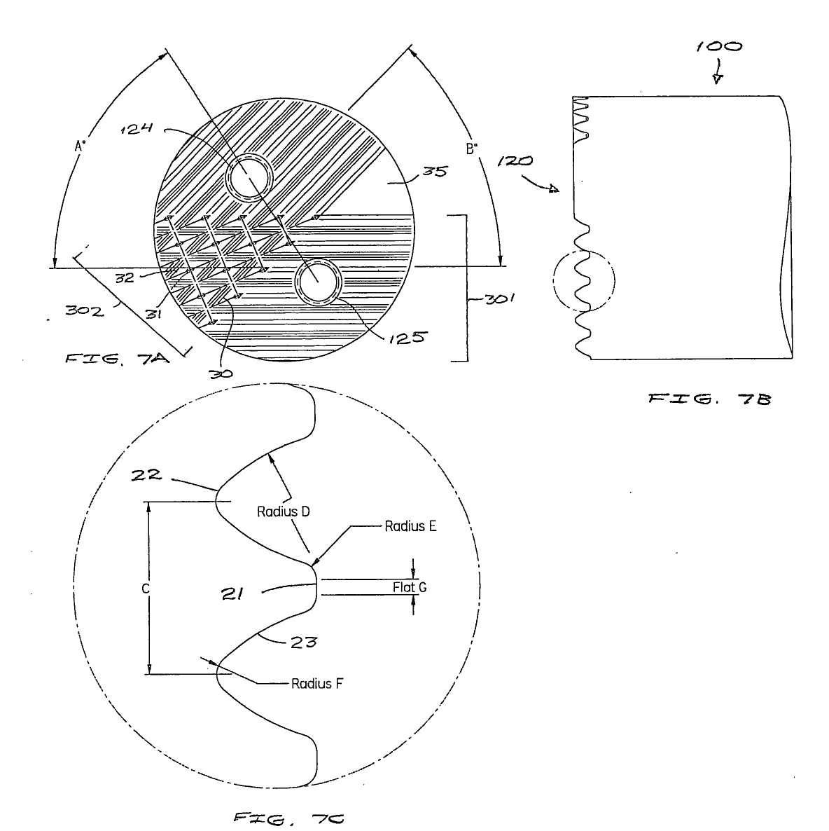

FIGS. 6A-6C illustrate another embodiment of the oblique angle intersecting first and second sets of serrations 301, 302 on the attachment end 120 of a shank 100, wherein the number of serrations in each set 301, 302 is greater as a result of a smaller groove-to-groove lateral dimension C as indicated on FIG. 6C. The greater number of serrations of each of the sets 301, 302 results in an increased area of intersection 30 and islands 31 therein, and a reduced area 35 where there are no serrations and no intersection of serrations. The material at area 35 can be separately removed or is otherwise eliminated by for example the formation of flutes in the shank 100. The ridges 22 and grooves 21 may be radiused at the same or different radii or otherwise contoured, and the flanks 23 cut straight or curvilinear.

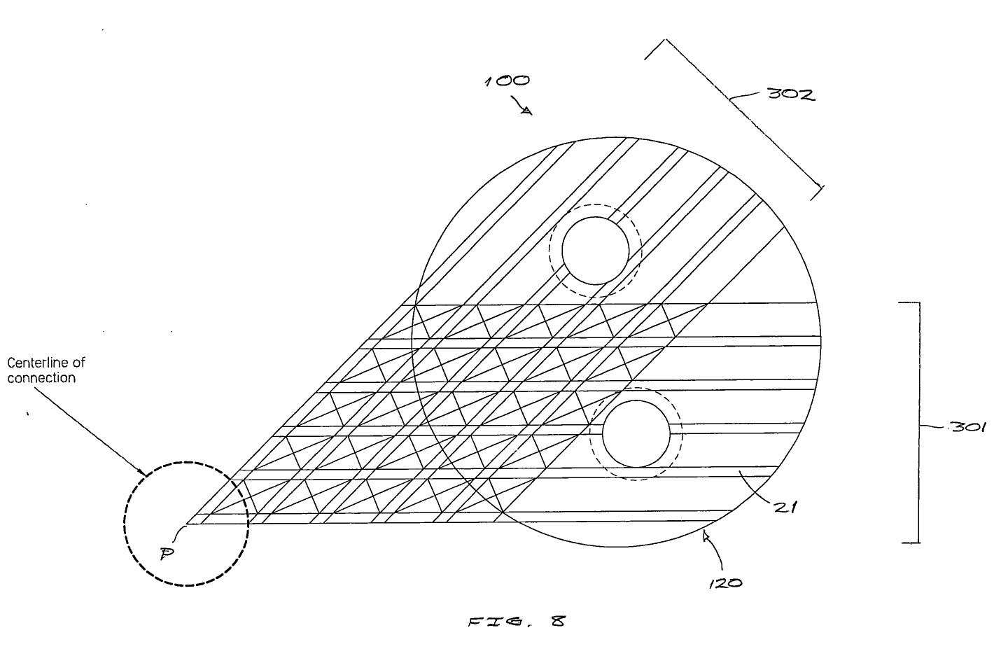

FIGS. 7A-7C illustrate another embodiment of the oblique angle intersecting first and second sets of serrations 301, 302 on the attachment end 120 of a shank 100, wherein the total number of serrations of each set 301, 302 is reduced as a result of an increased groove-to-groove lateral dimension C as indicated on FIG. 7C. The reduced number of serrations of each of the sets 301, 302 results in a reduced area of intersection 30 and islands 31 therein. As in other embodiments, the area 35 can be separately removed or reduced in profile to the depth of grooves 21, or is otherwise eliminated as result of further forming of the shank such as formation of chip flutes which have an area which covers the extent of area 35. As will be further described, the ridges 22 and grooves 21 may be radiused at the same or different radii or otherwise contoured as shown, and the flanks 23 cut straight or curvilinear.

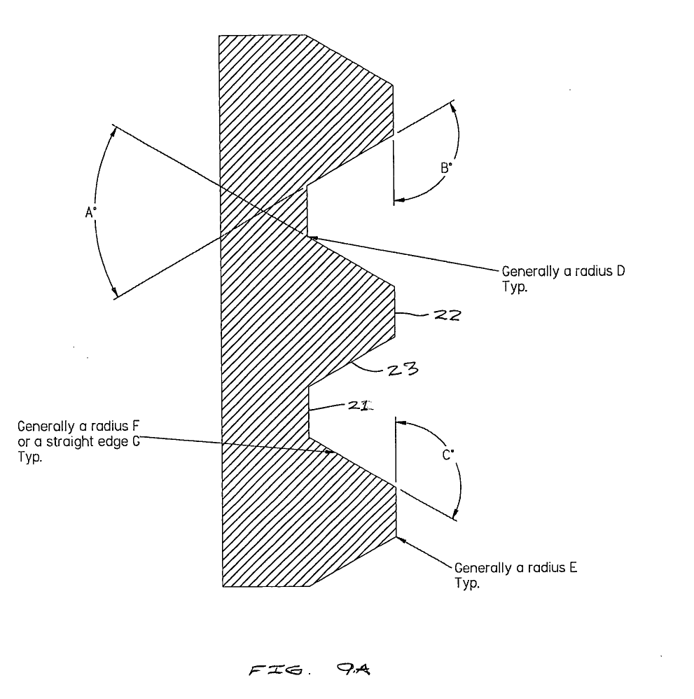

FIG. 8 illustrates a projection of the oblique angle of intersection of the first and second sets of serrations 301, 302 from the point P, which is the vertex, i.e., the point at which the sides of an angle intersect) of the triangle formed by the outermost serrations of the first and second sets of serrations. The point P is located off the axis of the shank 100 and, in this particular case, off the entire attachment end 120 of the shank 100. Although illustrated with reference to a shank 100, the point P of projection of the oblique angle of intersection of the first and second sets of serrations 201, 202 on the drill tip 10 or blank 15 or other driven component is similarly located off-axis and more preferably off of the interface end 20. The location of the projection point P off-axis from the driving component (i.e. shank) and driven component such as a drill tip or cutting piece or other member is what provides the single on-axis location of the two components at the interface of the serrations.

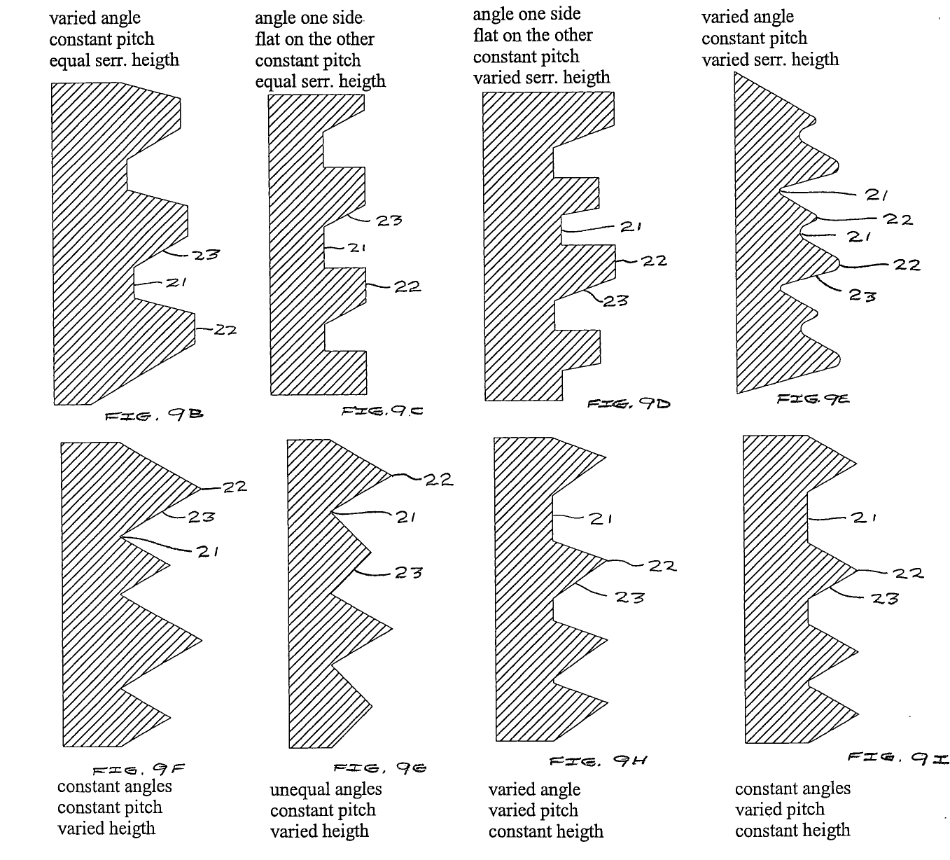

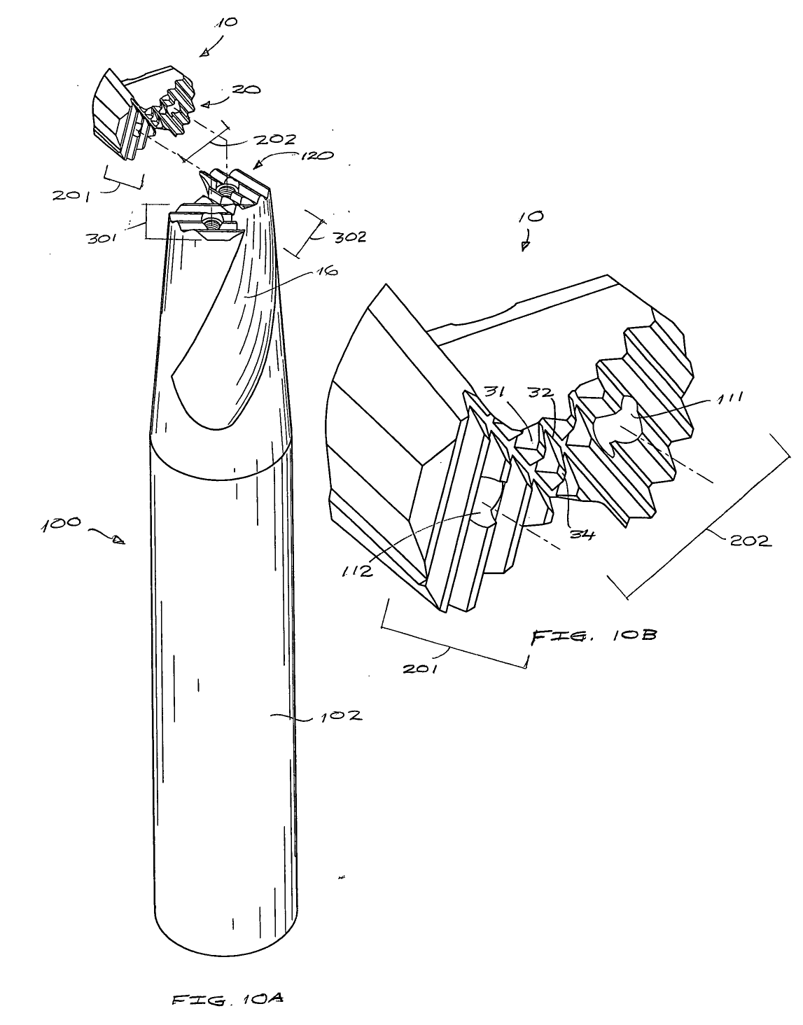

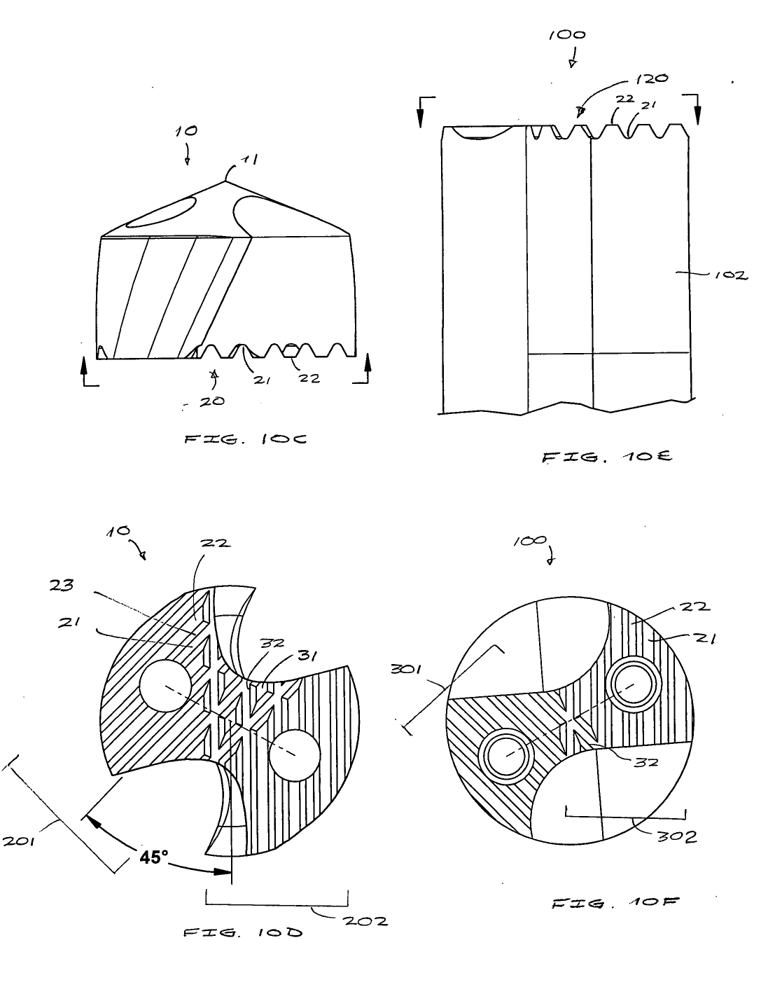

FIGS. 9A-9I illustrates various representative profiles of serrations which may be formed as any of the serration sets 201, 202, 301, 302 on either component of the interface, i.e., on the interface end 20 of a driven piece or component, or on the attachment end 120 of a shank 100. As illustrated, the design variable include the profiles of the grooves 21, ridges 22 and flanks 23, including the depth and width of the grooves 21, angle of the flanks 23, width and contour of the ridges 22 (dictated in part by the spacing and width of the grooves 21. The serration profile may be symmetric and repeated as shown in FIG. 9A, or asymmetric in one or more aspects as shown in FIGS. 9B-91, such as alternating flank angles, ridge elevations, groove depth, groove width, and the profiles or shapes of the grooves, flanks and ridges. Any of these forms can be made as serration sets at any oblique angle of intersection on at any interface or engagement end of a piece for precise on-axis location and torsional drive.

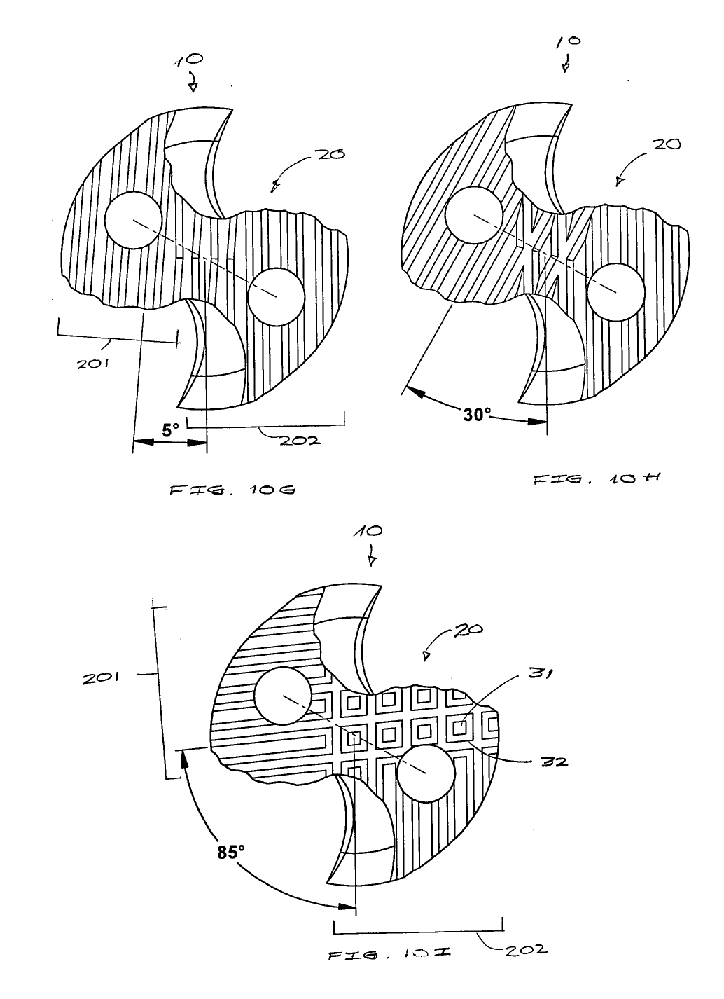

FIGS. 10A-10F illustrate a specific implementation of the location and drive concept of the invention, with a drill shank 100 and drill tip 10, with the first and second sets of serrations 201, 202 of the drill tip 10 meshing with the first and second sets of serrations 301, 302 on the attachment end 120 of the drill shank 100. FIGS. 10D and 10F illustrate an alternate oblique angle of intersection, 45 (forty-five) degrees, that the serrations 201, 202 and 301, 302 may be formed at. FIGS. 10G-10I illustrate, with reference to the interface end 20 of the drill tip 10, other representative alternate oblique angles of intersection of the first and second sets of serrations, 201 and 202, including 5 (five) degrees (FIG. 10G), 30 (thirty) degrees (FIG. 10H), and 85 (eighty-five) degrees (FIG. 101).

FIGS. 11A-11G illustrate another application of the oblique angle serration location and drive interface of the invention, as may be applied to a boring tool, indicated generally at 400, which includes a boring head 410 which has an interface end 420 formed with first and second sets of oblique angle serrations 201, 202 as previously described, for meshed engagement with the attachment end 120 of tool shank 100 as previously described. An axial through-bore 440 is provided in the boring head 410 for installation of a fastener (not shown) through the boring head into a co-axial tap 450 in the tool shank 100 at the attachment end 120. Other fastening arrangements may be used for securement of the working or driven component such as the boring head 410 to the tool shank 100. The boring head 410 provides a mounting structure for a boring insert 430 as known in the art. The meshed engagement of the first and second sets of serrations 201, 202 and 301, 302, The meshed engagement of the first and second sets of serrations 201, 202 and 301, 302, which may be formed at any oblique angle between 0 (zero) and 90 (ninety) degrees as previously described, provides precise on-axis location of the boring head 410 and optimal torque transfer drive to the boring insert 430 even when located far from the axis of the tool shank 100 and boring head 410. While the location and drive interface 1 creates only one exact orientation and position of the boring head 410, i.e. the driven component, upon the attachment end 120 of the shank 100, i.e. the drive component, and achieves alignment of the longitudinal axis of the boring head 410/driven component with the longitudinal axis of the shank 100/drive component, boring head 410/driven component may have additional structure or mass which is not equally distributed from the aligned longitudinal axes or from the location and drive interface 1.

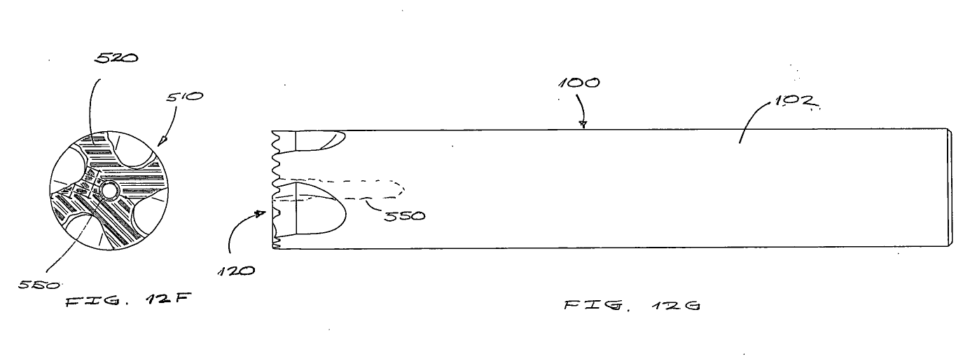

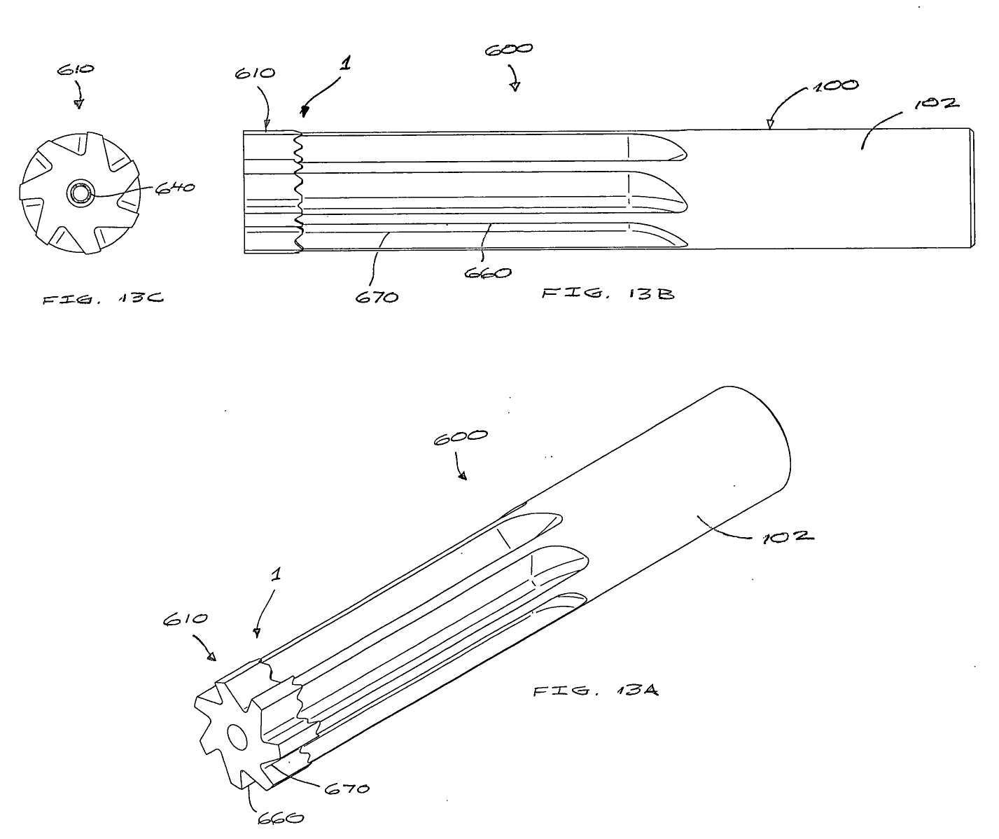

FIGS. 12A-12G illustrate another application of the oblique angle serration location and drive interface of the invention, as may be applied to an endmill tool, indicated generally at 500, which includes an endmill 510 which has an interface end 520 formed with first and second sets of oblique angle serrations 201, 202 as previously described, for meshed engagement with the attachment end 120 of tool shank 100 having matching first and second sets of oblique angle serrations 301, 302, as previously described. An axial through-bore 540 is provided in the endmill 510 for installation of a fastener (not shown) through the boring head into a co-axial tap 550 in the tool shank 100 at the attachment end 120. Other fastening arrangements may be used for securement of the working or driven component such as the endmill 510 to the tool shank 100. The endmill 510 has one or more cutting edges 560 and flutes 570 which may extend on to the tool shank body 102, past the interface as known in the art. The meshed engagement of the first and second sets of serrations 201, 202 and 301, 302, which may be formed at any oblique angle between 0 (zero) and 90 (ninety) degrees as previously described, provides precise on-axis location and optimal torque transfer drive to the endmill 510.

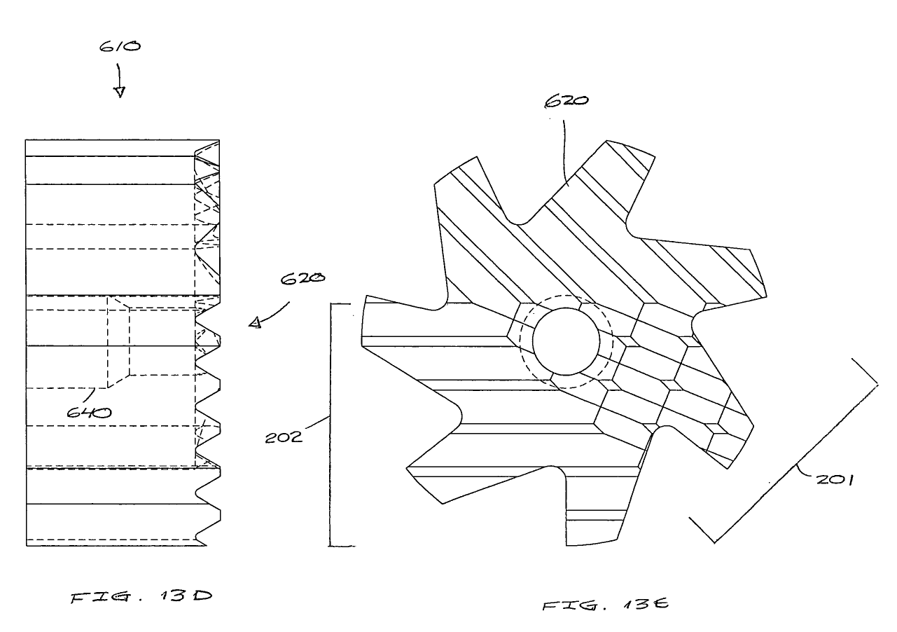

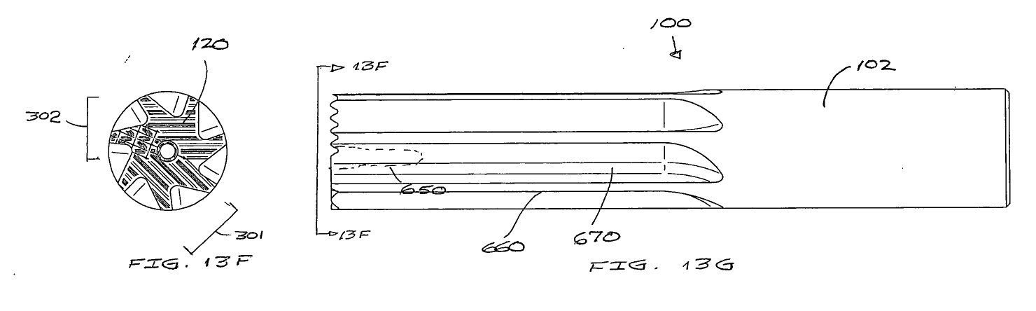

FIGS. 13A-13G illustrate another application of the oblique angle serration location and drive interface of the invention, as may be applied to an reamer tool, indicated generally at 600, which includes an reamer head 610 which has an interface end 620 formed with first and second sets of oblique angle serrations 201, 202 as previously described, for meshed engagement with the attachment end 120 of tool shank 100, having matching first and second sets of oblique angle serrations 301, 302 as previously described. An axial through-bore 640 is provided in the reamer head 610 for installation of a fastener (not shown) through the reamer head into a co-axial tap 650 in the tool shank 100 at the attachment end 120. Other fastening arrangements may be used for securement of the working or driven component such as the reamer head 610 to the tool shank 100. The reamer head 610 has one or more cutting edges 660 and flutes 670 which may extend on to the tool shank body 102, past the interface as known in the art. The meshed engagement of the first and second sets of serrations 201, 202 and 301, 302, which may be formed at any oblique angle between 0 (zero) and 90 (ninety) degrees as previously described, provides precise on-axis location and optimal torque transfer drive to the reamer head 610.

Although described with reference to machine tools, the oblique angle serration location and drive interface of the disclosure is applicable to any mechanical coupling for torque transfer (“drive”) between components. Non-limiting examples include drive shaft coupling, axle drive connection to gears or wheels, clutches, and any other rotational drive or torque application.

1. A location and drive interface for a torque transfer connection between a cutting tool and a shank, the shank having an attachment end for connection to an interface end of a cutting tool,
the attachment end of the shank having first an second sets of parallel serrations, the first set of serrations on the attachment end at an oblique angle relative to the second set of serrations on the attachment end;
the interface end of the cutting tool having first and second sets of parallel serrations which mesh with the first and second sets of serrations on the attachment end of the shank.

2. The location and drive interface of claim 1 wherein the oblique angle is between zero degrees and ninety degrees.

3. The location and drive interface of claim 1 wherein the first and second sets of serrations on the interface end of the cutting tool intersect on the interface end of the cutting tool.

4. The location and drive interface of claim 1 wherein the first and second sets of serrations on the attachment end of the shank intersect on the attachment end of the shank.

5. The location and drive interface of claim 1 wherein the first and second sets of parallel serrations on the interface end of the cutting tool intersect at the oblique angle on the interface end of the cutting tool to form one or more islands with a diamond-shaped perimeter on the attachment end of the cutting tool.

6. The location and drive interface of claim 1 wherein the first and second sets of parallel serrations on the attachment end of the shank intersect at the oblique angle on the attachment end of the shank to form one or more islands with a diamond-shaped perimeter on the connection end of the shank.

7. The location and drive interface of claim 1 wherein the first and second sets of serrations on the attachment end of the shank are formed by parallel grooves and ridges configured to mesh with the first and second sets of serrations on the interface end of the cutting tool.

8. The location and drive interface of claim 1 wherein the first and second sets of serrations on the interface end of the cutting tool are formed by parallel grooves and ridges configured to mesh with the first and second sets of serrations on the attachment end of the shank.

9. The location and drive interface of claim 1 wherein a point of projection of the oblique angle of the first and second sets of serrations on the attachment end of the shank is located off the attachment end of the shank.

10. The location and drive interface of claim 1 wherein a point of projection of the oblique angle of the first and second sets of serrations on the interface end of the cutting is located off the interface end of the cutting tool.

11. The location and drive interface of claim 3 wherein the first and second sets of serrations on the interface end of the cutting tool intersect on the interface end of the cutting tool intersect in an area of intersection that is less than the area of the first and second sets of serrations on the interface end of the cutting tool.

12. The location and drive interface of claim 4 wherein the first and second sets of serrations on the attachment end of the shank intersect on the attachment end of the shank intersect in an area of intersection that is less than the area of the first and second sets of serrations on the attachment end of the shank.

13. The location and drive interface of claim 3 wherein the first and second sets of serrations on the interface end of the cutting tool intersect on the interface end of the cutting tool in an area of intersection within which a longitudinal axis of the cutting tool is located.

14. The location and drive interface of claim 4 wherein the first and second sets of serrations on the attachment end of the shank intersect on the attachment end of the shank in an area of intersection within which a longitudinal axis of the shank is located.

15. The location and drive interface of claim 1 further comprising at least one fastener which extends through the cutting tool and into the shank and through the location and drive interface.

16. The location and drive interface of claim 1 further comprising at least two fasteners which extend through the cutting tool and into the shank and through the location and drive interface.

17. The location and drive interface of claim 16 wherein at least one fastener is located lateral to a longitudinal axis of the cutting tool.

18. The location and drive interface of claim 16 wherein at least one fastener is located lateral to a longitudinal axis of the shank.

19. The location and drive interface of claim 1 wherein profiles of the first and second sets of serrations of the cutting tool are substantially the same as profiles of the first and second sets of serrations of the shank.

20. The location and drive interface of claim 1 wherein the first and second sets of serrations of the cutting tool and the first and second sets of serrations of the shank are formed by alternating grooves and ridges, wherein the grooves are radiused.

21. The location and drive interface of claim 1 wherein the first and second sets of serrations of the cutting tool and the first and second sets of serrations of the shank are formed by alternating grooves and ridges, wherein the ridges are truncated or radiused.

22. The location and drive interface of claim 1 wherein the first and second sets of serrations of the cutting tool and the first and second sets of serrations of the shank are formed by alternating grooves and ridges, with flanks of the grooves extending to the ridges, and wherein the flanks are linear or curvilinear.

23. The location and drive interface of claim 1 wherein the first and second sets of serrations of the cutting tool and the first and second sets of serrations of the shank are formed by alternating grooves and ridges, wherein the grooves are formed in the interface end of the cutting tool to a common depth.

24. The location and drive interface of claim 1 wherein the first and second sets of serrations of the cutting tool and the first and second sets of serrations of the shank are formed by alternating grooves and ridges, wherein the grooves are formed in the interface end of the cutting tool to different depths.

25. The location and drive interface of claim 1 wherein the cutting tool has an outer radius and flutes, and the first and second sets of serrations on the interface end of the cutting tool extend from the outer radius to the flutes.

26. The location and drive interface of claim 1 wherein the shank has an outer radius and flutes, and the first and second sets of serrations on the attachment end of the shank extend from the outer radius to the flutes.

27. The location and drive interface of claim 1 further comprising flutes formed in the cutting tool and the shank, and the flutes are aligned by the location and drive interface.

28. The location and drive interface of claim 1 further comprising a cutting insert attached to the cutting tool.

29. The location and drive interface of claim 28 wherein the cutting insert is attached to the cutting tool at a point or points lateral to a longitudinal axis of the cutting tool.

30. The location and drive interface of claim 29 wherein the cutting insert is attached to the cutting tool at a point or points lateral to the location and drive interface.

31. The location and drive interface of claim 1 wherein the cutting tool comprises a cutting edge which is aligned with a cutting edge of the shank by the location and drive interface, the aligned cutting edge of the cutting tool and the shank extending across the location and drive interface.

32. A location and drive interface for torque transfer connection of a driven component to a drive component, the location and drive interface comprising:
a driven component having an interface end with first and second sets of serrations formed at an oblique angle, the first set of serrations on the interface end formed at an oblique angle relative to the second set of serrations on the interface end;
a drive component having an attachment end with first and second sets of serrations formed at an oblique angle, the first set of serrations on the attachment end formed at an oblique angle relative to the second set of serrations on the attachment end.

33. The location and drive interface of claim 32 wherein the first and second sets of serrations on the interface end of the driven component intersect on the interface end of the driven component to form an area of intersection with one or more islands in the area of intersection, each of the one or more islands having a diamond-shaped perimeter.

34. The location and drive interface of claim 33 wherein a longitudinal axis of the driven component is within the area of intersection.

35. The location and drive interface of claim 32 wherein the first and second sets of serrations on the attachment end of the drive component intersect on the attachment end of the drive component to form an area of intersection with one or more islands in the area of intersection, each of the one or more islands having a diamond-shaped perimeter.

36. The location and drive interface of claim 32 wherein the first and second sets of serrations on the interface end of the driven component are engageable with the first and second sets of serrations on the attachment end of the drive component in only one orientation of the driven component relative to the drive component.

37. The location and drive interface of claim 32 wherein the first and second sets of serrations on the interface end of the driven component are engageable with the first and second sets of serrations on the attachment end of the drive component in only one orientation of the driven component relative to the drive component, and wherein a longitudinal axis of the driven component is aligned with a longitudinal axis of the drive component.

38. The location and drive interface of claim 32 wherein the first and second sets of serrations on the interface end of the driven component are engageable with the first and second sets of serrations on the attachment end of the drive component in only one orientation of the driven component relative to the drive component, and wherein an outer diameter of the driven component is aligned with an outer diameter of the drive component.

39. The location and drive interface of claim 32 wherein the first and second sets of serrations on the interface end of the driven component are engageable with the first and second sets of serrations on the attachment end of the drive component in only one orientation of the driven component relative to the drive component, and wherein flutes of the driven component are aligned with flutes of the drive component.

40. The location and drive interface of claim 32 wherein a total number or serrations of the first and second sets of serrations on the interface end of the driven component is equal to a total number of serrations of the first and second sets of serrations on the attachment end of the drive component.

41. The location and drive interface of claim 32 wherein the driven component is selected from the group comprised of: a drill tip, a blank, an intermediate coupling, a cutting tool, a reaming tool, a boring tool, an endmill and a rotary component.

42. The location and drive interface of claim 32 further comprising at least one fastener which extends through the driven component into the drive component and through the location and drive interface.

43. A locating and torque transfer coupling interface between a driven component and a drive component for single orientation of the driven component on an attachment end of the drive component and axial alignment of the driven component with the drive component, the coupling interface comprising:
first and second sets of serrations on an interface end of the driven component, the first set of serrations on the interface end of the driven component formed at an oblique angle relative to the second set of serrations on the interface end of the driven component;
first and second sets of serrations on the attachment end of the drive component which mesh with the first and second sets of serrations on the interface end of the driven component in a single position which aligns a longitudinal axis of the driven component with a longitudinal axis of the drive component.

44. The locating and torque transfer coupling interface of claim 43 wherein the first and second sets of serrations on the interface end of the driven component intersect on the interface end of the driven component at the oblique angle to form an area of intersection which is smaller than an area covered by the first and second sets of serrations on the interface end.

45. The locating and torque transfer coupling interface of claim 43 wherein the first and second sets of serrations on the attachment end of the drive component intersect on the attachment end of the drive component at the oblique angle to form an area of intersection which is smaller than an area covered by the first and second sets of serrations on the attachment end.
